(19) United States
(12) Patent Application Publication
(10) Pub. No.: US 2004/0255280 A1
(43) Pub. Date: Dec. 16, 2004

(54) System and method for executing composite commands with consecutive single keystrokes

(76) Inventors: Shih-Li Wen, Taipei (TW); Yun-Yang Chang, Taipei (TW); Hsiang-Min Liu, Taipei (TW); Chie-Chien Chien, Taipei (TW); I-Ping Hu, Taipei (TW); Chiu-Yin Lin, Taipei (TW)

Correspondence Address: BIRCH STEWART KOLASCH & BIRCH, PO BOX 747, FALLS CHURCH, VA, 22040-0747, US

(21) Appl. No.: 10/459,452

(22) Filed: Jun. 12, 2003

(51) Int. Cl. G06F 9/44

(52) U.S. Cl. 717/136; 717/110

(57) ABSTRACT

A system and method for executing composite commands with consecutive single keystrokes to be applied to executable computer system platforms. By utilizing a string of digits entered by the user, the system searches a built-in digit-to-program index database for the target application program or function item associated with this string of digits, and then executes the program or function item.

### BACKGROUND OF THE INVENTION

1. Field of Invention

The invention relates to a method for executing programs or specific functions on an executable computer platform, and more particularly to a method for executing programs of operating systems or initiating a function within a program by consecutively entering a string of digits.

2. Related Art

With the advancement of computer technology, computer software as well as hardware have been continuously evolving and developing. Many software systems have evolved from providing simple, basic functions to very new and complex ones. However, to most computer users, especially those with a limited background and knowledge in computer software and hardware, these new and complex software techniques and functions are usually very difficult to learn and effectively operate. This can discourage users from learning the new functions. The cause of the difficulty is that a new user does not know where to start among numerous commands in order to execute what he or she intends to. In many cases, a user can only execute what he or she intends to execute after several trials and errors.

Currently, the main method of executing a single program within an operating system is by moving cursor over the desired application program, then quickly double-clicking the left button on the mouse. There are shortcomings with this method: if the user wants to execute a program in an operation system, he or she needs to use mouse to click through layers of menus in order to reach and execute the desired program. For example, when a user wants to execute “Start/Programs/Accessories/Paint”, the user needs first move the cursor to and click the “Start” button at the lower-left corner of the screen, enter the “Programs” menu, move the cursor to and click “Accessories” from the menu, then move the cursor again to click the “Paint” menu item. While a user is moving the cursor and clicking on menus layer by layer for choosing the desired program, the computer always displays all the programs in the current layer for the user to choose from. Therefore, the user has to spend some time on each layer in order to find the right program, and then click on it to enter the next layer or start the program. As a result, a lot of time is wasted, and the computer is cumbersome to operate.

In the current computer systems, if a user wants to initiate some function within a program, he or she needs to follow the same method mentioned above—navigating through layers of menus until finally reaching the desired function. This method is as cumbersome as the one describe above.

In current computer systems, the ability to execute a single function by entering a single digit has been implemented. The shortcoming of this is that only one digit can be analyzed at a time, and only one instruction—the one that maps to this digit—can be executed. The user needs to input the digits one by one in order to enter layers of menus before reaching the desired command. Even though the single numeric keystroke has replaced the operation of the mouse, it is still inconvenient to operate, and cannot reach the target function quickly.

### SUMMARY OF THE INVENTION

In light of the problems mentioned above, the main objective of the invention is to provide a system to be applied on executable computer platforms for reducing the layered displays associated with executing applications or functions by executing composite commands with consecutive single keystrokes.

The system for executing composite commands with consecutive single keystrokes, as disclosed by the invention, can be applied to either operating systems or programs. The system uses a list of digits entered by the user, searches the built-in digit-to-program index database for the target application program or function item which maps to the string of digits, then executes the program or function. The system reduces the layered displays as shown in current modes of operation, making the operations more convenient and less time-consuming.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow illustration only, and thus are not limitative of the present invention, and wherein:

FIG. 1 illustrates the operation architecture of the system for executing composite commands with consecutive single keystrokes disclosed by the invention.

FIG. 2 is an operational flow chart for the system for executing composite commands with consecutive single keystrokes disclosed by the invention.

FIG. 3 is a detailed operational flow chart for step 120.

FIG. 4 is an example of applying the invention to execute a program from a window of the operating system.

FIG. 5 is an example of applying the invention to execute a function from a window of a program.

### DETAILED DESCRIPTION OF THE INVENTION

The invention is a system and method to be applied on executable system platforms. It uses consecutively entered single keystrokes to initiate a program from the operating system, or to start some function within a program. “Single keystrokes” means the numeric keys 0-9. When a user wants to execute an application or a function, he or she only needs to enter a series of numbers. The system queries the built-in database to locate the instruction associated with this series of numbers. Once the instruction is located, it is executed immediately, thereby reducing the layers of menus as in current methods of executing programs and functions.

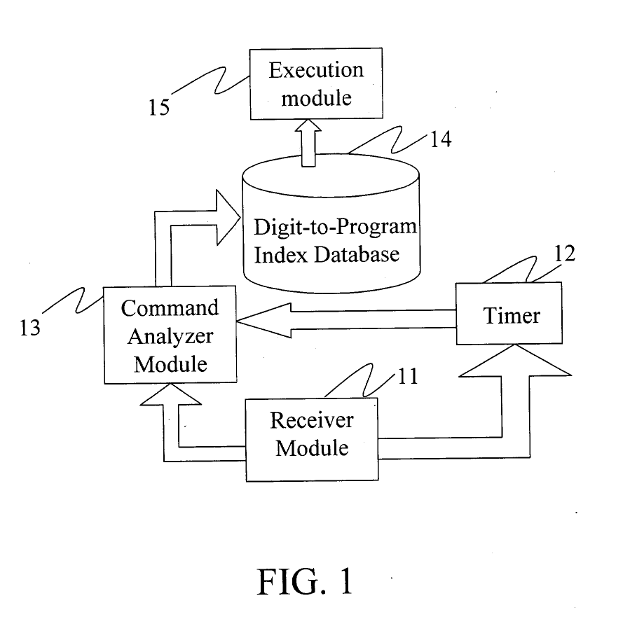

Referring to FIG. 1, the software architecture of the invention is comprised of one receiver module 11, one timer 12, one command analyzer module 13, one digit-to-program index database 14, and one execution module 15.

The receiver module 11 receives a string of digits input by a user into the system, and transmits the string of digits. The timer module 12 processes timing; it starts a timer when it receives a digit from the receiver module 11. If there is no input after a pre-defined time period, it transmits confirmation messages. If a digit is received before the pre-defined time period is over, the timer 12 resets the timer to 0, waits for the next input and repeats the flow.

The command analyzer module 13 receives digits from the receiver module 11 and stores them in a stack. The command analyzer module 13 starts analyzing and transmitting the stored digits upon receiving a confirmation message from timer module 12. The digit-to-program index database 14 is a database for storing strings of digits and their associated programs or functions. The execution module 15 executes the program or function associated with the string of digits.

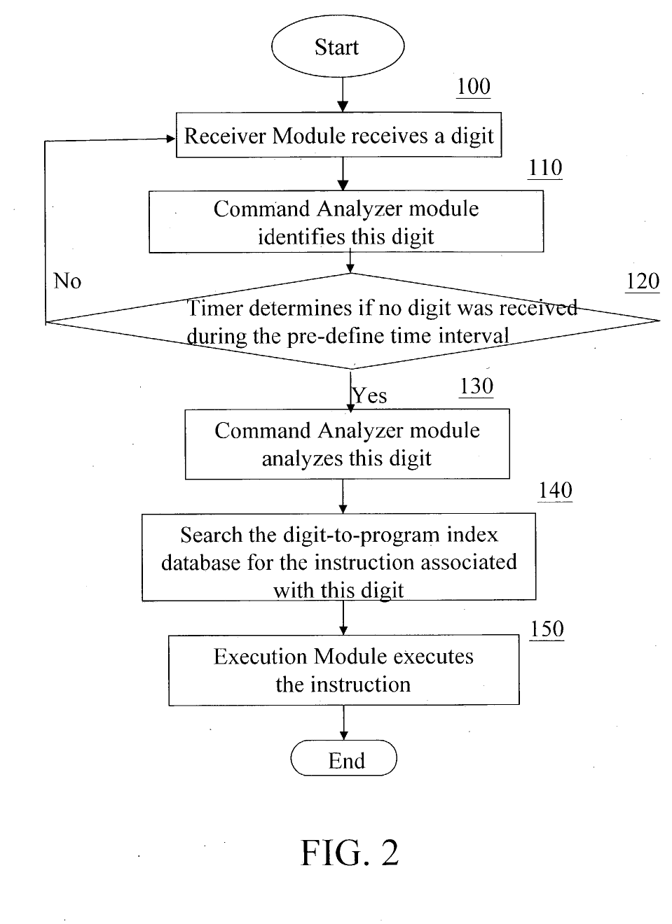

Referring to FIG. 2, the remainder of this section describes the operation steps of the invention. Please refer to FIG. 1 whenever the operation architecture of the system is mentioned.

When a user enters a digit, the receiver module 11 receives the digit (step 100). Then, the receiver module 11 transmits this digit to the command analyzer module 13, where the entered digit is identified (step 110) and stored in a stack. At the same time, the receiver module 100 transmits this digit to the timer module 12, which starts its timer upon the arrival of the digit. After a pre-defined time period has expired, the timer module 12 checks if it has received other digits (step 120). If a new digit is received within this time period, the timer module 12 resets its timer to 0, restarts the timer and waits for a pre-defined period of time before checking whether a new digit has arrived. The flow of operation continues to step 100. If no digit is received within the pre-defined time period, the timer module 12 transmits a confirmation message to the command analyzer module 13, which starts analyzing all the digits stored in the stack (step 130). The command analyzer module 13 transmits the analyzed string of digits to the digit-to-program index database 14, where the database is queried for the instruction associated with the string of digits (step 140). The associated instruction is either a program or a function item. The digit-to-program index database 14 transmits the resultant instruction from the query to the execution module 15, where the instruction is executed (step 150). As the final step, the result of the execution by the execution module 15 is displayed by a display module.

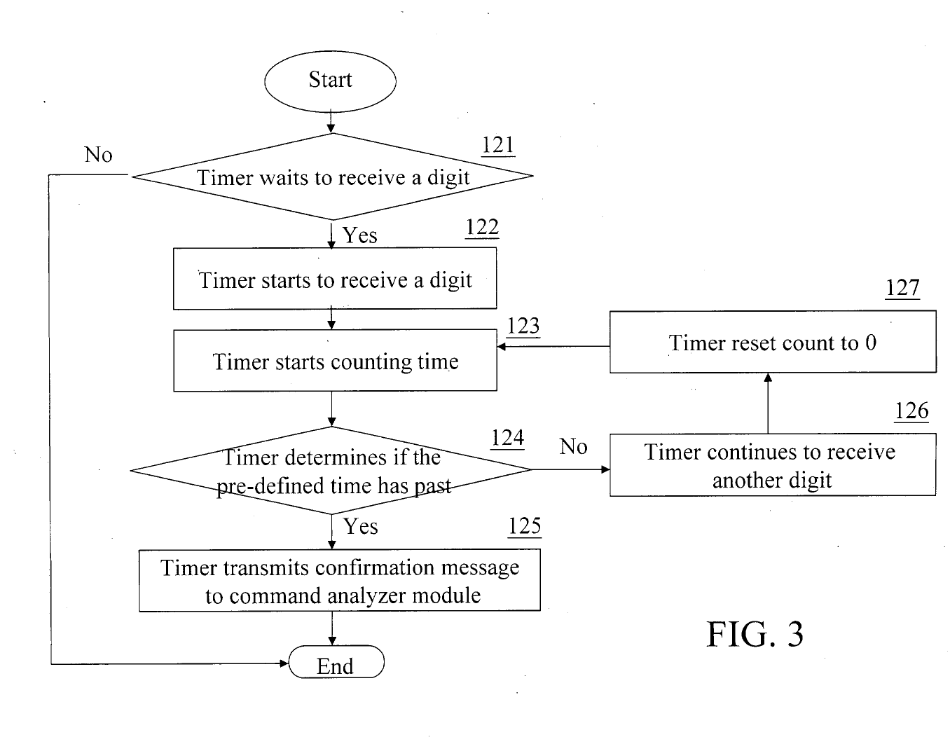

Please refer to FIG. 3 for the detailed sub-steps in the operation flow for step 120. The operational flow for step 120 is elaborated below:

Firstly, the timer module 12 waits to receive a digit (step 121). When the receiver module 11 transmits a digit to the timer module 12, the timer module 12 receives this digit (step 122). When the digit is received, the timer module 12 starts timing to track the time elapsed (step 123). The timer module 12 then determines whether the pre-defined time period has expired (step 124). If so, the timer module 12 transmits a confirmation message to the command analyzer module 13 (step 125). This is the end of the operation flow. If the timer module 12 receives a digit before the pre-defined time expires (step 126), the timer resets to 0 (step 127), restarts (step 123) and then continues with the operation flow.

The invention defines an additional designation key in the application window while the application is in the state of executing a function item. The designation key can be defined arbitrarily from any one of the numeric keys ranging from 0 to 9. While the application program is running, pressing this key in effect performs the edit functions of this program, for example, add, modify, delete, . . . etc. This improves the convenience of the operation for users.

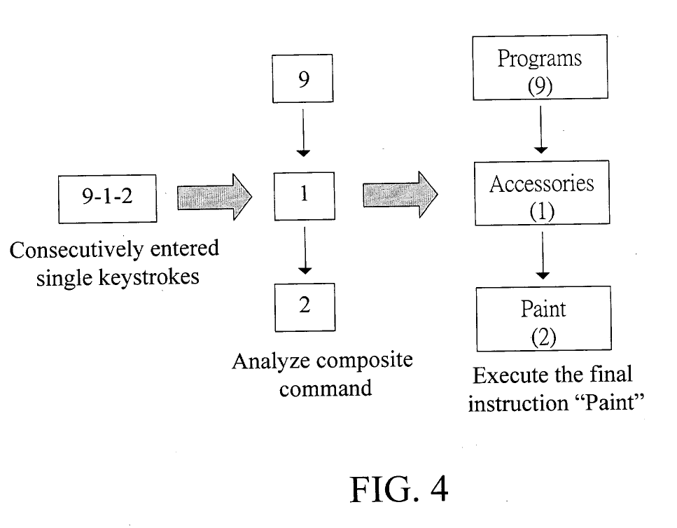

The practical applications of the invention for executing programs in the operating system's windows are illustrated in FIG. 4. The detailed description is provided below.

If a user wants to perform “Start/Programs/Accessories/Paint”, he or she enters the operation system's window, presses [9] to enter “Programs”, then presses [1] to enter “Accessories”, and finally presses [2] to enter “Paint”. The user goes directly into the “Paint” window, without waiting for the menus to appear at each layer. The elapsed time between the entering of the two consecutive digits has to be within the pre-defined amount. Otherwise, the user will be given the menu items of the current layer.

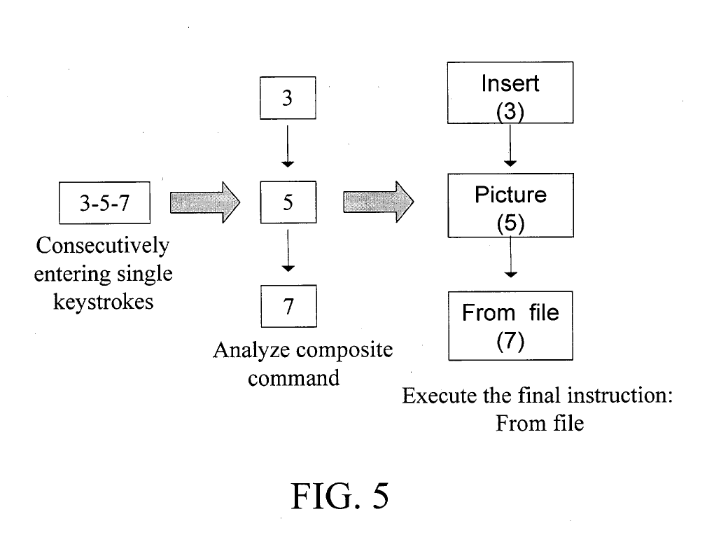

Another practical example for the application of the invention is in performing functions within an application, as illustrated in FIG. 5. The detailed description is provided below.

While editing a document, for example, if a user wants to perform the “insert/picture/from file” function, he or she first enters the window of the editing software, presses [3] to enter the “Insert” function, then enters [5] to enter “picture”, and finally [7] to enter “from file”. At this point, the user is presented with file names as choices for insertion. There is no need to select one function item, wait for the next menu page to show up, and then make another choice. This simplified operation saves user's time. While using the document editing software, as well as other application programs, if a user wants to perform functions such as add, modify, or delete, all the user needs to do is press the designated key. When the key is pressed, all the menu items for editing functions appear for the user to choose, for example add, modify, delete, . . . etc.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A system for executing composite commands with consecutive single keystrokes, comprising:
a receiver module, for receiving a string of digits input into the system and transmitting the string of digits;
a timer module, for receiving the string of digits, and transmitting a time message after receiving the string of digits and waiting for a pre-define time period;
a command analyzer module, for receiving the string of digits, and once the time message is received, the command analyzer module stops receiving any digits while the command analyzer module proceeds to analyze the string of digits;
a digit-to-program index database, for storing the strings of digits and the instructions corresponding to the strings of digits; and
an execution module, for executing a final instruction corresponding to the string of digits.

2. The system for executing composite commands with consecutive single keystrokes of claim 1, wherein the consecutive single keystrokes consisting of numeric keys from 0 to 9.

3. The system for executing composite commands with consecutive single keystrokes of claim 1, wherein the system also includes the definition of a designation key for executing a data alteration function item of an application program.

4. The system for executing composite commands with consecutive single keystrokes of claim 1, wherein the execution module includes a display module for displaying the final instruction corresponding to the string of digits.

5. A method for executing composite commands with consecutive single keystrokes, applying to an executable computer platform, for performing function items in a plurality of application programs, which comprises the step of:
receiving a string of digits while executing the application program;
identifying the string of digits;
confirming that no other digits were received during a pre-defined time interval;
searching a digit-to-program index database for a function item corresponding to the string of digits; and
executing the function item corresponding to the string of digits.

6. The system for executing composite commands with consecutive single keystrokes of claim 5, wherein the step where confirming that no other digits were received during a pre-defined time interval, further comprising the following steps:
waiting to receive a digit by a timer;
starting to receive the digit by the timer;
starting to count time by the timer;
deciding if the pre-defined time interval has past by the timer; and
transmitting a confirmation message to the command analyzer module by the timer.

7. The system for executing composite commands with consecutive single keystrokes of claim 6, wherein in the step where deciding if the pre-defined time interval has past by the timer, if the timer receiving another digit before the pre-defined time interval past, the timer will reset time count to 0, and repeat the step where starting to count time by the timer.

8. The system for executing composite commands with consecutive single keystrokes of claim 5, wherein the consecutive single keystrokes consisting of numeric keys from 0 to 9.

9. The method for executing composite commands with consecutive single keystrokes of claim 5, wherein the method further comprising a step of obtaining a designation key for performing a data alteration function within the application program.

10. The system for executing composite commands with consecutive single keystrokes of claim 9, wherein the designation key is chosen from one of the numeric keys from 0 to 9 and to be defined.

11. The method for executing composite commands with consecutive single keystrokes of claim 5, wherein the step for executing the function item corresponding to the string of digits further comprising a step of displaying the function item.

12. A method for executing composite commands with consecutive single keystrokes, applying to on an executable computer platform, for executing a plurality of application programs in an operating system, which comprises the steps of:
receiving a string of digits while executing the operating system;
identifying the string of digits;
confirming that no other digits were received during a pre-defined time interval;
searching a digit-to-program index database for the application program corresponding to the string of digits; and
executing the application program corresponding to the string of digits.

13. The system for executing composite commands with consecutive single keystrokes of claim 12, wherein the step where confirming that no other digits were received during a pre-defined time interval, further comprising the following steps:
waiting to receive a digit by a timer;
starting to receive the digit by the timer;
starting to count time by the timer;
deciding if the pre-defined time interval has past by the timer; and
transmitting a confirmation message to the command analyzer module by the timer.

14. The system for executing composite commands with consecutive single keystrokes of claim 13, wherein in the step where deciding if the pre-defined time interval has past by the timer, if the timer receiving another digit before the pre-defined time interval past, the timer will reset time count to 0, and repeat the step where starting to count time by the timer.

15. The system for executing composite commands with consecutive single keystrokes of claim 12, wherein the consecutive single keystrokes consisting of numeric keys from 0 to 9.

16. The method for executing composite commands with consecutive single keystrokes of claim 12, wherein the method further comprising a step of obtaining a designation key for performing a data alteration function within the application program.

17. The system for executing composite commands with consecutive single keystrokes of claim 16, wherein the designation key is chosen from one of the numeric keys from 0 to 9 and to be defined.

18. The method for executing composite commands with consecutive single keystrokes of claim 12, wherein the step for executing the application program corresponding to the string of digits further comprising a step of displaying the application program.
